(19) United States
(12) Patent Application Publication
(10) Pub. No.: US 2026/0323681 A1
(43) Pub. Date: Oct. 15, 2026

(54) COMMUNICATION SYSTEM, COMMUNICATION METHOD, AND COMMUNICATION TERMINAL

(71) Applicant: Nintendo Co., Ltd., Kyoto (JP)

(72) Inventors: Masahiko TSUYAMA, Kyoto (JP); Yohei KOJIMA, Kyoto (JP)

(21) Appl. No.: 19/531,359

(22) Filed: Feb. 5, 2026

(30) Foreign Application Priority Data
Feb. 7, 2025 (JP) 2025-019164

(51) Int. Cl. H04W 72/56; H04L 9/40; H04W 76/10

(52) U.S. Cl. CPC H04W 72/56; H04L 63/0435; H04W 76/10

(57) ABSTRACT

A communication system includes a first communication terminal including a plurality of wireless communication controllers and a second communication terminal including one or more wireless communication controllers. The first communication terminal transmits data including information on the plurality of wireless communication controllers in the first communication terminal to the second communication terminal. The second communication terminal transmits data including information on the one or more wireless communication controllers in the second communication terminal to the first communication terminal. The first communication terminal and the second communication terminal each generate a shared key. The second communication terminal associates each of the plurality of wireless communication controllers in the first communication terminal with the shared key generated at the second communication terminal. The first communication terminal associates each of the one or more wireless communication controllers in the second communication terminal with the shared key generated at the first communication terminal.

This non-provisional application is based on Japanese Patent Application No. 2025-019164 filed with the Japan Patent Office on Feb. 7, 2025, the entire contents of which are hereby incorporated by reference.

### FIELD

The present disclosure relates to a communication system, a communication method, and a communication terminal.

### BACKGROUND AND SUMMARY

For example, in wireless communication or the like in conformity with Bluetooth®, pairing processing is required for establishing a wireless connection.

There is room for improvement in pairing processing in an example where at least one of a plurality of communication terminals to wirelessly be connected to each other includes a plurality of wireless communication controllers.

(Configuration 1) An exemplary embodiment provides a communication system that includes a first communication terminal including a plurality of wireless communication controllers and a second communication terminal including one or more wireless communication controllers. The first communication terminal transmits data including information on the plurality of wireless communication controllers in the first communication terminal to the second communication terminal. The second communication terminal transmits data including information on the one or more wireless communication controllers in the second communication terminal to the first communication terminal. The first communication terminal and the second communication terminal each generate a shared key. The second communication terminal associates each of the plurality of wireless communication controllers in the first communication terminal with the shared key generated at the second communication terminal. The first communication terminal associates each of the one or more wireless communication controllers in the second communication terminal with the shared key generated at the first communication terminal.

According to Configuration 1, since the second communication terminal can receive the data including the information on the plurality of wireless communication controllers in the first communication terminal and associate each of the plurality of wireless communication controllers with the generated shared key, time required for processing can be shorter than in an example where processing for generating the shared key for each of wireless communication controllers in the first communication terminal is performed.

(Configuration 2) In Configuration 1, the data to be transmitted by the first communication terminal may include priority information. The second communication terminal may determine, in accordance with the priority information, a wireless communication controller to be a connection destination among the plurality of wireless communication controllers in the first communication terminal when the second communication terminal establishes a wireless connection to the first communication terminal.

(Configuration 3) In Configuration 1 or 2, the priority information may be based on an order, in the data, of information on the plurality of wireless communication controllers.

(Configuration 4) In any of Configurations 1 to 3, the second communication terminal may associate a single shared key with each of the plurality of wireless communication controllers in the first communication terminal.

(Configuration 5) In any of Configurations 1 to 3, the second communication terminal may associate a different shared key with each of the plurality of wireless communication controllers in the first communication terminal.

(Configuration 6) In any of Configurations 1 to 5, the first communication terminal may further include a wired communication controller. The second communication terminal may further include a wired communication controller. The first communication terminal may transmit the data including the information on the plurality of wireless communication controllers in the first communication terminal to the second communication terminal when the first communication terminal is connected via a wireless connection to the second communication terminal and when the first communication terminal is connected via a wired connection to the second communication terminal.

(Configuration 7) In any of Configurations 1 to 6, the first communication terminal may transmit the data including the information on the plurality of wireless communication controllers in the first communication terminal to the second communication terminal when the first communication terminal receives predetermined information from the second communication terminal.

(Configuration 8) In Configuration 7, the predetermined information may be in an advertising packet transmitted by the second communication terminal.

(Configuration 9) In Configuration 7 or 8, the first communication terminal may transmit the data including information on one wireless communication controller among the plurality of wireless communication controllers in the first communication terminal to the second communication terminal when the first communication terminal does not receive the predetermined information from the second communication terminal.

(Configuration 10) In any of Configurations 1 to 9, the second communication terminal may transmit information indicating a key generation scheme supported by the second communication terminal to the first communication terminal. The first communication terminal may select at least one of the key generation scheme indicated by the information received from the second communication terminal or a predetermined key generation scheme.

(Configuration 11) In any of Configurations 1 to 10, the first communication terminal and the second communication terminal may determine whether shared keys that they hold match with each other. The first communication terminal and the second communication terminal may generate the shared key when the shared keys that they hold do not match with each other.

(Configuration 12) An exemplary embodiment provides a method of communication between a first communication terminal and a second communication terminal. The method includes transmitting, at the first communication terminal that includes a plurality of wireless communication controllers, data including information on the plurality of wireless communication controllers in the first communication terminal to the second communication terminal, transmitting, at the second communication terminal that includes one or more wireless communication controllers, data including information on the one or more wireless communication controllers in the second communication terminal to the first communication terminal, generating, at each of the first communication terminal and the second communication terminal, a shared key, associating, at the second communication terminal, each of the plurality of wireless communication controllers in the first communication terminal with the shared key generated at the second communication terminal, and associating, at the first communication terminal, each of the one or more wireless communication controllers in the second communication terminal with the shared key generated at the first communication terminal.

(Configuration 13) An exemplary embodiment provides a communication terminal. The communication terminal includes one or more wireless communication controllers. The communication terminal transmits data including information on the one or more wireless communication controllers in the communication terminal to a second communication terminal, to which the communication terminal is wirelessly connected, including a plurality of wireless communication controllers when the communication terminal receives data including information on the plurality of wireless communication controllers in the second communication terminal from the second communication terminal, generates a shared key between the communication terminal and the second communication terminal, and associates each of the plurality of wireless communication controllers in the second communication terminal with the generated shared key.

(Configuration 14) An exemplary embodiment provides a communication method to be performed by a communication terminal. The communication method includes transmitting data including information on one or more wireless communication controllers in the communication terminal to a second communication terminal, to which the communication terminal is wirelessly connected, including a plurality of wireless communication controllers when the communication terminal receives data including information on the plurality of wireless communication controllers in the second communication terminal from the second communication terminal, generating a shared key between the communication terminal and the second communication terminal, and associating each of the plurality of wireless communication controllers in the second communication terminal with the generated shared key.

(Configuration 15) An exemplary embodiment provides a communication terminal. The communication terminal includes a plurality of wireless communication controllers. The communication terminal transmits data including information on the plurality of wireless communication controllers in the communication terminal to a second communication terminal, to which the communication terminal is wirelessly connected, including one or more wireless communication controllers, receives data including information on the one or more wireless communication controllers in the second communication terminal from the second communication terminal, generates a shared key between the communication terminal and the second communication terminal, and associates each of the one or more wireless communication controllers in the second communication terminal with the generated shared key.

(Configuration 16) An exemplary embodiment provides a communication method to be performed by a communication terminal. The communication method includes transmitting data including information on a plurality of wireless communication controllers in the communication terminal to a second communication terminal, to which the communication terminal is wirelessly connected, including one or more wireless communication controllers, receiving data including information on the one or more wireless communication controllers in the second communication terminal from the second communication terminal, generating a shared key between the communication terminal and the second communication terminal, and associating each of the one or more wireless communication controllers in the second communication terminal with the generated shared key.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 shows an exemplary illustrative non-limiting drawing illustrating an exemplary configuration of a communication system according to the present embodiment.

FIG. 2 shows an exemplary illustrative non-limiting sequence chart illustrating an exemplary processing procedure in first pairing processing according to the present embodiment.

FIG. 3 shows an exemplary illustrative non-limiting drawing illustrating exemplary pairing information.

FIG. 4 shows an exemplary illustrative non-limiting flowchart illustrating processing for determination as to start of pairing processing at a central terminal according to the present embodiment.

FIG. 5 shows an exemplary illustrative non-limiting sequence chart illustrating an exemplary processing procedure in second pairing processing according to the present embodiment.

FIG. 6 shows an exemplary illustrative non-limiting drawing illustrating updating processing in pairing information of the central terminal and a peripheral terminal according to the present embodiment.

### DETAILED DESCRIPTION OF NON-LIMITING EXAMPLE EMBODIMENTS

The present embodiment will be described in detail with reference to the drawings. The same or corresponding elements in the drawings have the same reference characters allotted and description thereof will not be repeated.

### A. Exemplary Configuration of Communication System

An exemplary configuration of a communication system 1 according to the present embodiment will initially be described. Communication system 1 includes a plurality of communication terminals capable of communicating. Communication system 1 can be applied, for example, to a game system.

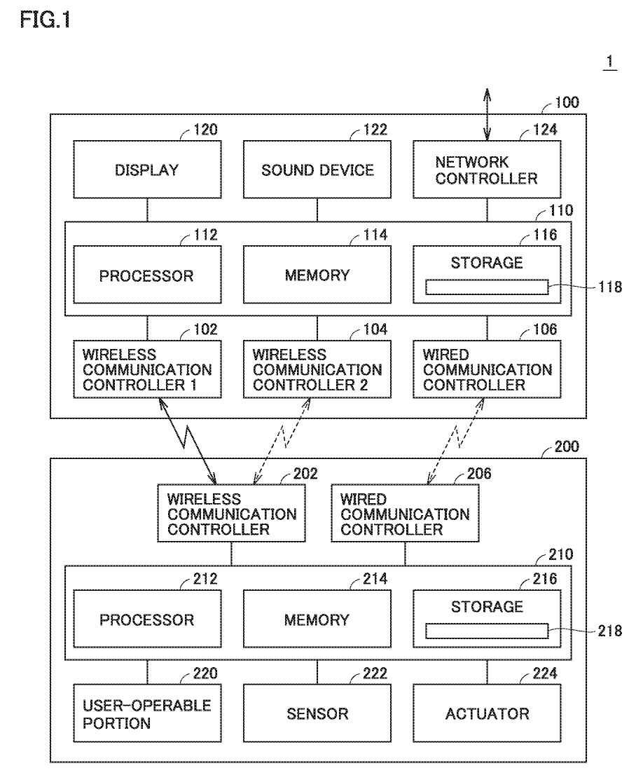

Referring to FIG. 1, communication system 1 includes a central terminal 100 and a peripheral terminal 200 by way of example of a communication terminal. Communication system 1 may include a plurality of central terminals 100 and/or a plurality of peripheral terminals 200.

Central terminal 100 may operate as a peripheral terminal and peripheral terminal 200 may operate as a central terminal.

For example, one central terminal 100 may wirelessly communicate simultaneously with a plurality of peripheral terminals 200. One peripheral terminal 200 may wirelessly be connectable to a plurality of different central terminals 100.

In an example where communication system 1 is applied to a game system, central terminal 100 may be a main device that executes a game application and peripheral terminal 200 may be a game controller. Communication system 1 may be applied to a system other than the game system, and an apparatus to serve as a central terminal and a peripheral terminal is not limited. At least one of the central terminal or the peripheral terminal may be, for example, a general-purpose personal computer, a smartphone, a speaker, a printer, an input device, a camera, or the like.

Central terminal 100 includes a plurality of wireless communication controllers. Central terminal 100 shown in FIG. 1 includes a first wireless communication controller 102 and a second wireless communication controller 104 by way of example of the plurality of wireless communication controllers.

Peripheral terminal 200 includes one or more wireless communication controllers. Peripheral terminal 200 shown in FIG. 1 includes a wireless communication controller 202 by way of example of the one or more wireless communication controllers.

First wireless communication controller 102 or second wireless communication controller 104 of central terminal 100 can wirelessly communicate with wireless communication controller 202 of peripheral terminal 200. Wireless communication may be in conformity, for example, with Bluetooth®.

Central terminal 100 and peripheral terminal 200 may be capable of various types of wireless communication such as ZigBee®, wireless LAN (IEEE 802.11), and infrared communication.

Central terminal 100 further includes a wired communication controller 106. Peripheral terminal 200 further includes a wired communication controller 206. When central terminal 100 and peripheral terminal 200 are connected to each other by a wired connection, wired communication controller 106 of central terminal 100 may communicate by wired communication with wired communication controller 206 of peripheral terminal 200. For example, central terminal 100 may be configured such that one or more peripheral terminals 200 are attachable thereto.

Central terminal 100 further includes a control unit 110, a display 120, a sound device 122, and a network controller 124 by way of example.

Control unit 110 of central terminal 100 includes, for example, a processor 112, a memory 114, and a storage 116. A storage device or a storage medium such as memory 114 or storage 116 may be called a "memory".

Processor 112 is a processing entity for performing processing provided by central terminal 100. Processor 112 is implemented, for example, by a central processing unit (CPU), a graphics processing unit (GPU), or the like. Processor 112 loads a system program or an application program stored in storage 116 onto memory 114 and executes the same, to thereby perform processing as will be described later.

Memory 114 is a storage device or a storage medium accessible by processor 112. Memory 114 may be, for example, a volatile storage device such as a dynamic random access memory (DRAM) or a static random access memory (SRAM).

Storage 116 may be, for example, a non-volatile storage medium such as a hard disk or a flash memory. Storage 116 may be, for example, a storage medium attachable to and removable from central terminal 100, such as an optical disc or a cartridge. The communication terminal may be implemented by combining central terminal 100 and a storage medium with each other.

Pairing information 118 may be stored in storage 116.

Display 120 shows an image based on a result or the like of processing by processor 112.

Sound device 122 may include, for example, at least one of a microphone or a speaker.

Network controller 124 is responsible for communication with another apparatus over a not-shown network.

Peripheral terminal 200 further includes a control unit 210, a user-operable portion 220, a sensor 222, and an actuator 224.

Control unit 210 of peripheral terminal 200 includes, for example, a processor 212, a memory 214, and a storage 216. Processor 212, memory 214, and storage 216 are similar to processor 112, memory 114, and storage 116 described above, respectively. Pairing information 218 may be stored in storage 216.

User-operable portion 220 receives a user operation on peripheral terminal 200. User-operable portion 220 may be, for example, a cross-shaped key, a button, a lever, a stick, or the like. Information indicating the user operation received by user-operable portion 220 may be transmitted to central terminal 100 by wireless communication or wired communication.

Sensor 222 may be, for example, a device that obtains various types of information on peripheral terminal 200, such as a vibration sensor, an acceleration sensor, a temperature sensor, a pressure sensor, or a global positioning system (GPS) receiver.

Actuator 224 may be, for example, a device that gives tactile information to a user, such as a vibrator or an electrothermal element. An operation instruction for actuator 224 may be transmitted from central terminal 100 by wireless communication or wired communication.

### B. Pairing Processing

Pairing processing in communication system 1 according to the present embodiment will now be described. In communication system 1 according to the present embodiment, first pairing processing and second pairing processing may be executable. In the description below, in a context where the first pairing processing and the second pairing processing are not distinguished from each other, they are collectively simply referred to as "pairing processing."

The pairing processing is processing for storing, by each of the central terminal and the peripheral terminal, a communication counterpart and associating a shared key with each communication counterpart. The shared key is used for encrypting and decrypting a communication channel between the paired central terminal and peripheral terminal. Since the pairing processing is performed for storing the communication counterpart and holding the shared key, a wireless connection may be or may not be maintained after the pairing processing.

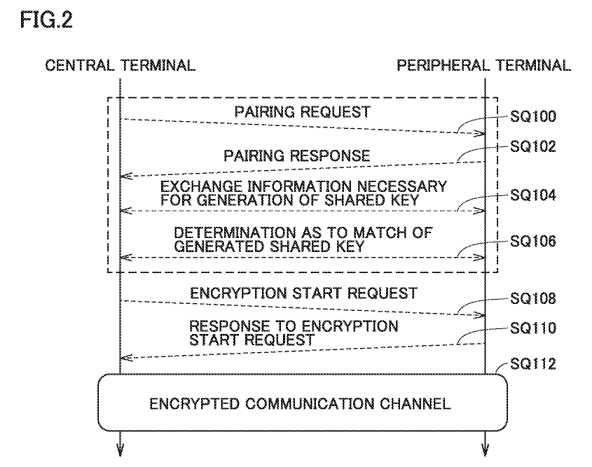

An exemplary processing procedure in the first pairing processing will be described with reference to FIG. 2. Prior to the first pairing processing shown in FIG. 2, a wireless connection has been established between the central terminal and the peripheral terminal. Therefore, the central terminal has already known an address (for example, Bluetooth® Device Address) of the wireless communication controller of the peripheral terminal and the peripheral terminal has already known an address of the wireless communication controller of the central terminal.

Referring to FIG. 2, the central terminal transmits a pairing request to the peripheral terminal (sequence SQ100). The pairing request includes information (for example, Bluetooth® version information or the like) on the wireless communication controller to be used for communication at the central terminal.

The peripheral terminal transmits a pairing response to the central terminal in response to the pairing request from the central terminal (sequence SQ102). The pairing response includes information (for example, Bluetooth® version information or the like) on the wireless communication controller to be used for communication at the peripheral terminal.

The central terminal and the peripheral terminal exchange information necessary for generation of the shared key (sequence SQ104). Each of the central terminal and the peripheral terminal generates the shared key based on the exchanged information. The central terminal and the peripheral terminal then determine that the generated shared keys match with each other (sequence SQ106). After the central terminal and the peripheral terminal determine that the generated shared keys match with each other, they store the respective shared keys.

The central terminal and the peripheral terminal may generate the shared key based on common information that both of the terminals have. In this case, information does not have to be exchanged only for generation of the shared key (which is also similar in second pairing processing which will be described later).

Sequences SQ100 to SQ106 correspond to the first pairing processing.

Thereafter, when the central terminal transmits an encryption start request to the peripheral terminal (sequence SQ108) and the peripheral terminal transmits response to the encryption start request to the central terminal (sequence SQ110), encrypted communication is started between the central terminal and the peripheral terminal (sequence SQ112).

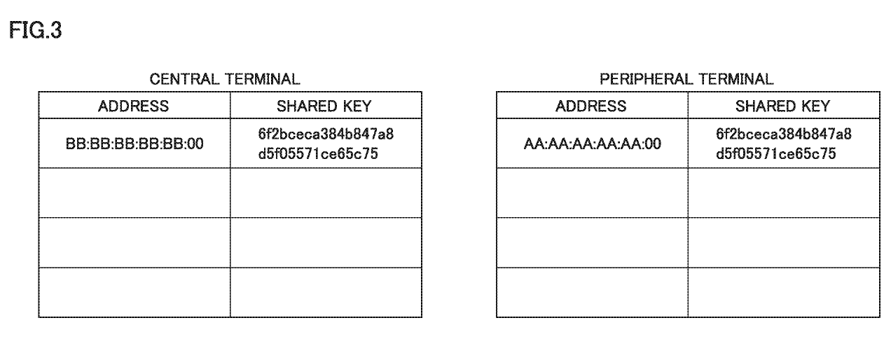

Exemplary pairing information will be described with reference to FIG. 3. FIG. 3 shows exemplary pairing information after the pairing processing is performed between the central terminal and the peripheral. Referring to FIG. 3, pairing information of the central terminal and the peripheral terminal may include, for example, one or more entries where an address and a shared key are associated with each other.

The pairing information of the central terminal includes one entry where the address of the wireless communication controller of the peripheral terminal and the shared key shared with the peripheral terminal are associated with each other. Similarly, the pairing information of the peripheral terminal includes one entry where the address of the wireless communication controller of the central terminal and the shared key shared with the central terminal are associated with each other.

Central terminal 100 according to the present embodiment may include two wireless communication controllers (first wireless communication controller 102 or second wireless communication controller 104). The first pairing processing is performed for determining the shared key between one wireless communication controller and one wireless communication controller. Therefore, central terminal 100 requires the first pairing processing for each wireless communication controller. Then, in communication system 1, the second pairing processing as below may be executable.

The second pairing processing may be performed, for example, when at least one of the central terminal or the peripheral terminal includes a plurality of wireless communication controllers.

More specifically, in one second pairing processing, information on a plurality of wireless communication controllers included in central terminal 100 or peripheral terminal 200 may be exchanged. Exchanged information may be information on all wireless communication controllers or information on at least one of the wireless communication controllers. The second pairing processing may be performed through a wired connection.

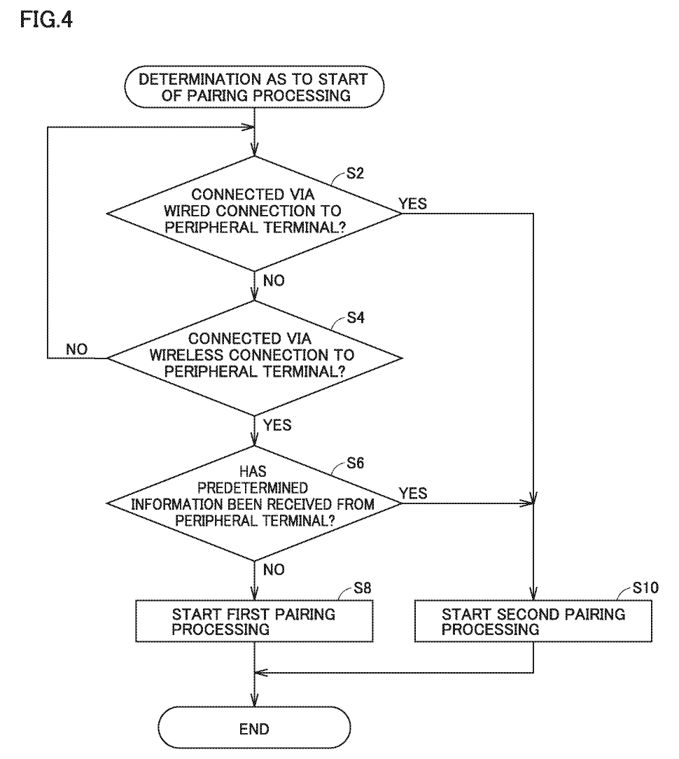

An exemplary processing procedure for determining start of the pairing processing at central terminal 100 will be described with reference to FIG. 4. Each step shown in FIG. 4 may be performed by execution of the system program by processor 112 of central terminal 100.

Referring to FIG. 4, central terminal 100 determines whether or not it has been connected to peripheral terminal 200 via a wired connection (step S2). When central terminal 100 determines that it has been connected to peripheral terminal 200 via the wired connection (YES in step S2), it starts the second pairing processing (step S10).

When central terminal 100 does not determine that it has been connected to peripheral terminal 200 via the wired connection (NO in step S2), central terminal 100 determines whether or not it has been connected to peripheral terminal 200 via the wireless connection (step S4). When central terminal 100 determines that it has been connected to peripheral terminal 200 via the wireless connection (YES in step S4), central terminal 100 determines whether or not it has received predetermined information from peripheral terminal 200 (step S6). The predetermined information includes information as to whether or not connected peripheral terminal 200 supports the second pairing processing as will be described later.

When central terminal 100 does not determine that it has been connected to peripheral terminal 200 via the wireless connection (NO in step S4), processing in step S2 or later is repeated.

Though FIG. 4 shows exemplary processing in an exemplary configuration where a wired connection and a wireless connection can be established between central terminal 100 and peripheral terminal 200, the configuration may be such that only one of the wired connection or the wireless connection can be established.

Though the second pairing processing can be performed in any case of the wired connection and the wireless connection in FIG. 4, the second pairing processing may be performed only in the wired connection or only in the wireless connection.

As shown in FIG. 4, central terminal 100 may start the second pairing processing when it is connected to peripheral terminal 200 via the wired connection and when it is connected to peripheral terminal 200 via the wireless connection.

Start by central terminal 100, of the second pairing processing when it is connected to peripheral terminal 200 via the wired connection is on the premise that peripheral terminal 200 connectable to central terminal 100 via the wired connection supports the second pairing processing in communication system 1 according to the present embodiment. Central terminal 100 may determine whether or not it receives predetermined information from peripheral terminal 200 after it is connected to peripheral terminal 200 via the wired connection.

Exemplary predetermined information for central terminal 100 to determine whether or not connected peripheral terminal 200 supports the second pairing processing will be described.

For example, in an example where central terminal 100 and peripheral terminal 200 support Bluetooth® Low Energy, peripheral terminal 200 can broadcast an advertising packet. The advertising packet broadcast by peripheral terminal 200 may include predetermined information indicating that peripheral terminal 200 supports the second pairing processing. Central terminal 100 may determine which of the first pairing processing and the second pairing processing it should perform, based on the advertising packet from peripheral terminal 200.

The advertising packet from peripheral terminal 200 does not have to include an expiration date.

For example, in an example where support of the second pairing processing has been known between central terminal 100 and peripheral terminal 200, the advertising packet is not essential. Therefore, communication system 1 according to the present embodiment may support only Bluetooth® Classic (Bluetooth® Basic Rate/Enhanced Data Rate).

In an example where central terminal 100 and peripheral terminal 200 are connected to each other via the wired connection, information can directly be exchanged and hence whether or not the second pairing processing is supported may be determined between central terminal 100 and peripheral terminal 200 based on the exchanged information.

When central terminal 100 thus receives from peripheral terminal 200, the predetermined information indicating that peripheral terminal 200 supports the second pairing processing, it may start the second pairing processing.

Central terminal 100 does not have to determine whether or not it has received the predetermined information from peripheral terminal 200. Peripheral terminal 200 does not have to transmit the predetermined information. For example, central terminal 100 may start the second pairing processing when it is connected to peripheral terminal 200. When central terminal 100 thereafter determines that it is unable to perform the second pairing processing, for example, by receiving an error response from peripheral terminal 200, it may switch to the first pairing processing.

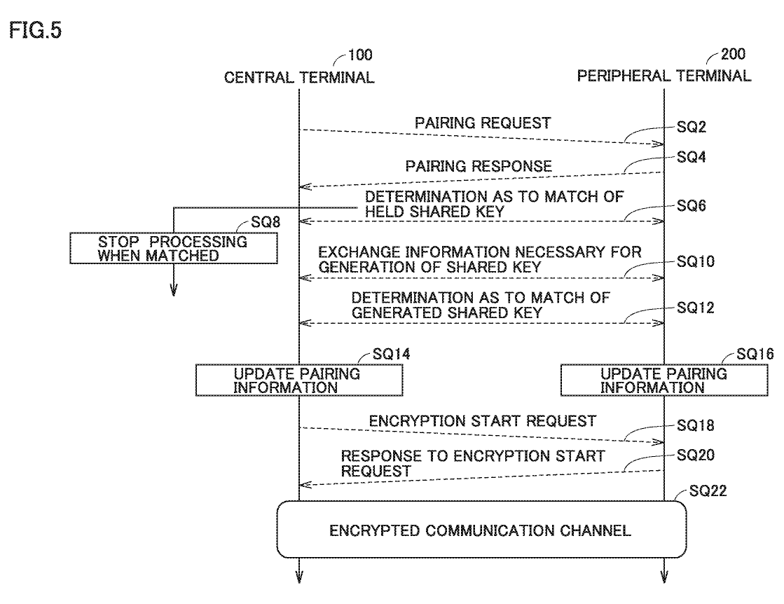

FIG. 5 is a sequence chart showing an exemplary processing procedure in the second pairing processing according to the present embodiment. Referring to FIG. 5, central terminal 100 transmits a pairing request to peripheral terminal 200 (sequence SQ2). Peripheral terminal 200 transmits a pairing response to central terminal 100 in response to the pairing request from central terminal 100 (sequence SQ4).

The pairing request transmitted in sequence SQ2 includes information on a plurality of wireless communication controllers included in central terminal 100. By way of example of the information on the plurality of wireless communication controllers, the pairing request may include the address of each wireless communication controller. The pairing request may include the number of wireless communication controllers included in central terminal 100.

In the example above, central terminal 100 includes two wireless communication controllers. Therefore, the pairing request transmitted by central terminal 100 includes, for example, "2", "AA:AA:AA:AA:AA:01", and "AA:AA:AA:AA:AA:00". "2" represents the number of wireless communication controllers included in central terminal 100, "AA:AA:AA:AA:AA:01" represents the address of second wireless communication controller 104, and "AA:AA:AA:AA:AA:00" represents the address of first wireless communication controller 102.

In the case of a wireless connection, of first wireless communication controller 102 and second wireless communication controller 104 of central terminal 100, the pairing request above is transmitted from the wireless communication controller used for the wireless connection.

Central terminal 100 may transmit priority information to peripheral terminal 200 together with information on the plurality of wireless communication controllers included in central terminal 100. By way of example, the priority information may be based on the order of addresses of the wireless communication controllers included in the pairing request transmitted by central terminal 100. In the pairing request, "AA:AA:AA:AA:AA:01" precedes within a frame, and "AA:AA:AA:AA:AA:01" indicates higher priority than "AA:AA:AA:AA:AA:00". The frame may be divided. Central terminal 100 may thus transmit to peripheral terminal 200, information on the wireless controller higher in priority earlier.

In order to distinguish between the first pairing processing (see FIG. 2) and the second pairing processing (see FIG. 5), the pairing request may include information indicating to which pairing processing it is directed. For example, identification information for specifying the pairing processing to be performed may be included in a header of the pairing request.

The pairing response transmitted in sequence SQ4 includes information on one or more wireless communication controllers included in peripheral terminal 200. By way of example of the information on the one or more wireless communication controllers, the pairing response may include the address of each wireless communication controller. The pairing response may include information indicating the number of wireless communication controllers included in peripheral terminal 200 and a supported key generation scheme.

In the example above, peripheral terminal 200 includes one wireless communication controller. Therefore, the pairing response transmitted by peripheral terminal 200 includes, for example, "1", "BB:BB:BB:BB:BB:00", and "2.51". "1" indicates the number of wireless communication controllers included in peripheral terminal 200, "BB:BB:BB:BB:BB:00" indicates the address of wireless communication controller 202, and "2.51" indicates version information which is exemplary information indicating the key generation scheme.

In an example where peripheral terminal 200 includes a plurality of wireless communication controllers, the pairing response may include, for example, "2", "BB:BB:BB:BB:BB:01", "BB:BB:BB:BB:BB:00", and "2.51".

Similarly to central terminal 100, peripheral terminal 200 may transmit priority information to central terminal 100 together with the information on the plurality of wireless communication controllers included in peripheral terminal 200. The priority information may be based on the order of addresses of the wireless communication controllers included in the pairing request transmitted by peripheral terminal 200.

A method of designating the priority information is not limited. By way of example, the number indicating priority and the address of the wireless communication controller may be brought in correspondence with each other and transmitted.

Central terminal 100 or peripheral terminal 200 does not have to transmit the priority information. When a communication counterpart of peripheral terminal 200 or central terminal 100 includes a plurality of wireless communication controllers, peripheral terminal 200 or central terminal 100 may randomly determine the wireless communication controller which is a connection destination, or may determine the wireless communication controller which is the connection destination based on information obtained at a time point of connection.

The pairing request or the pairing response may include information (for example, the Bluetooth® version information or the like) on the wireless communication controller.

The pairing request or the pairing response may be made up of one or more frames including information as described above. Data including the information on the plurality of wireless communication controllers included in central terminal 100 or data including the information on the one or more wireless communication controllers included in peripheral terminal 200 may be transmitted as being divided, so long as the second pairing processing can be performed with the data.

A data format in incorporating the information as described above in the pairing request and the pairing response may be defined under generic attribute profile (GATT) or any other method.

In succession, central terminal 100 and peripheral terminal 200 determine whether or not shared keys held thereby match with each other (sequence SQ6).

For example, central terminal 100 determines, by referring to pairing information 118, the shared key associated with the address of the wireless communication controller of peripheral terminal 200, encrypts data shared in advance with the shared key, and transmits the encrypted data to peripheral terminal 200. Peripheral terminal 200 determines, by referring to pairing information 218, the shared key associated with the address of the wireless communication controller of central terminal 100 and decrypts the received, encrypted data with the shared key. Peripheral terminal 200 determines whether or not the shared key held by central terminal 100 matches with the shared key held by peripheral terminal 200 by comparing a result of decryption with the data shared in advance.

Similarly, peripheral terminal 200 encrypts the data shared in advance with the shared key associated with the address of the wireless communication controller of central terminal 100 and transmits the encrypted data to central terminal 100. Central terminal 100 decrypts the received, encrypted data with the shared key associated with the address of the wireless communication controller of peripheral terminal 200. Central terminal 100 determines whether or not the shared key held by peripheral terminal 200 matches with the shared key held by central terminal 100 by comparing the result of decryption with the data shared in advance.

Central terminal 100 and peripheral terminal 200 suspend the pairing processing when the shared keys held thereby match with each other (sequence SQ8). In other words, central terminal 100 and peripheral terminal 200 do not perform processing in sequence SQ10 or later.

Central terminal 100 and peripheral terminal 200, on the other hand, may generate the shared key when the shared keys held thereby do not match with each other. More specifically, central terminal 100 and peripheral terminal 200 exchange information necessary for generation of the shared key (sequence SQ10). Each of central terminal 100 and peripheral terminal 200 generates the shared key based on the exchanged information. Central terminal 100 and peripheral terminal 200 thus exchange information and each generate the shared key. One shared key or a plurality of shared keys may be generated.

In generation of the shared key, the key generation scheme for generation of the shared key may be determined based on the version information included in the pairing response from peripheral terminal 200. For example, peripheral terminal 200 may support two key generation schemes. In this case, the two key generation schemes may include a basic key generation scheme and a key generation scheme higher in version than the basic key generation scheme. For example, the key generation scheme of the higher version is advantageous in being higher in security strength than the basic key generation scheme or being shorter in time period for generation. All terminals included in communication system 1, on the other hand, may support the basic key generation scheme.

Peripheral terminal 200 may support only the basic key generation scheme. In this case, the key generation scheme between central terminal 100 and peripheral terminal 200 does not have to be determined each time. The key generation scheme between central terminal 100 and peripheral terminal 200 may thus be fixed.

Peripheral terminal 200 may incorporate in the pairing response, the version information of the key generation scheme highest among the key generation schemes supported thereby. When central terminal 100 supports the key generation scheme indicated by the version information included in the pairing response from peripheral terminal 200, it may select that key generation scheme, and otherwise, it may select the basic key generation scheme. Central terminal 100 may transmit information indicating the selected key generation scheme to peripheral terminal 200 or may exchange information with peripheral terminal 200 by using a command in accordance with the selected key generation scheme.

Central terminal 100 may thus select one of the key generation scheme indicated by the information received from peripheral terminal 200 and the predetermined key generation scheme.

By adopting the selection method described above, the supported key generation scheme highest in version can be selected between central terminal 100 and peripheral terminal 200 as much as possible, and the shared key in accordance with the basic key generation scheme can more reliably be generated.

In an example where an algorithm in accordance with a Diffie-Hellman (DH) protocol is employed as the key generation scheme, each of central terminal 100 and peripheral terminal 200 generates a key pair (a private key and a public key) and transmits the generated public key to its communication counterpart. Each of central terminal 100 and peripheral terminal 200 generates the shared key by using its own private key and the public key of its communication counterpart received from the communication counterpart. In this case, in sequence SQ10, the public keys of central terminal 100 and peripheral terminal 200 may be exchanged.

Alternatively, each of central terminal 100 and peripheral terminal 200 may transmit a randomly generated data string to its communication counterpart. Each of central terminal 100 and peripheral terminal 200 may generate the shared key by using a data string generated thereby and a data string received from its communication counterpart. In this case, in sequence SQ10, a random data string may be exchanged.

Central terminal 100 and peripheral terminal 200 then determine that the generated shared keys match with each other (sequence SQ12). In sequence SQ12, whether or not the shared keys match with each other may be determined with a method as in sequence SQ6.

After central terminal 100 and peripheral terminal 200 determine that the generated shared keys match with each other, they update the pairing information (sequences SQ14 and SQ16). In other words, central terminal 100 associates each of the one or more wireless communication controllers included in peripheral terminal 200 with the generated shared key (sequence SQ14). Peripheral terminal 200 associates each of the plurality of wireless communication controllers included in central terminal 100 with the generated shared key (sequence SQ16).

Though central terminal 100 includes the plurality of wireless communication controllers in the example described above, peripheral terminal 200 may associate a single shared key with each of the plurality of wireless communication controllers included in central terminal 100. In this case, in sequences SQ10 and SQ12, one shared key is generated.

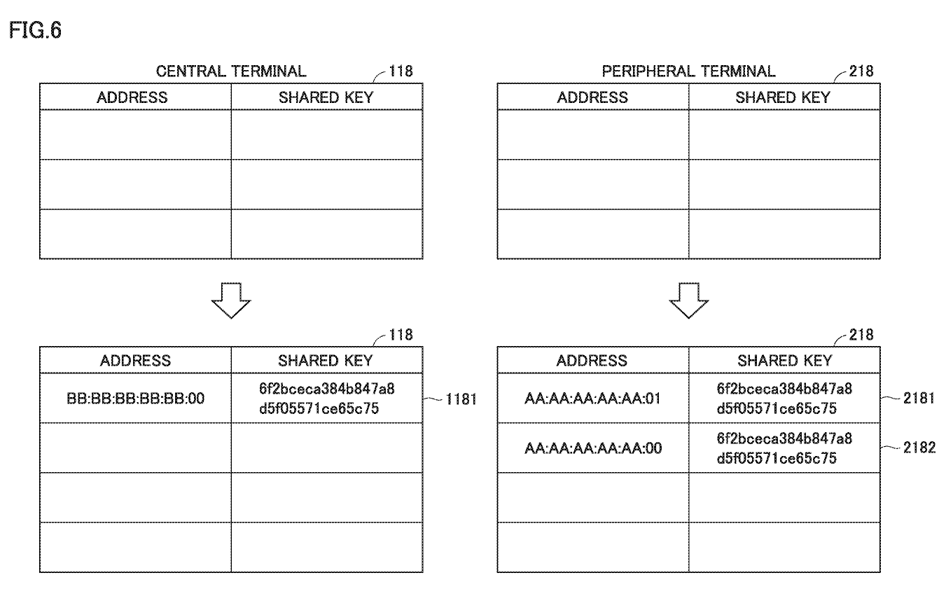

FIG. 6 is a diagram for illustrating updating processing in pairing information of central terminal 100 and peripheral terminal 200 according to the present embodiment.

Referring to FIG. 6, prior to start of the second pairing processing, pairing information 118 of central terminal 100 and pairing information 218 of peripheral terminal 200 are assumed as including no entry (a state at an upper side in FIG. 6).

When central terminal 100 updates pairing information 118 in sequence SQ14, one entry 1181 including the address of wireless communication controller 202 of peripheral terminal 200 and the generated shared key is added to pairing information 118 (a state at a lower side in FIG. 6). When peripheral terminal 200 updates pairing information 218 in sequence SQ16, a first entry 2181 including the address of second wireless communication controller 104 of central terminal 100 and the generated shared key and a second entry 2182 including the address of first wireless communication controller 102 of central terminal 100 and the generated shared key are added (the state at the lower side in FIG. 6).

The order of entries added to the pairing information may be in line with the order of transmission of addresses included in the pairing request transmitted by central terminal 100 or the order of transmission of addresses included in the pairing response transmitted by peripheral terminal 200.

For example, pairing information 218 (the state at the lower side in FIG. 6) shown in FIG. 6 is based on transmission of the address in the order of "AA:AA:AA:AA:AA:01" and "AA:AA:AA:AA:AA:00" in the pairing request transmitted by central terminal 100.

When central terminal 100 and peripheral terminal 200 establish a wireless connection, they search for the communication counterpart by referring to the pairing information of each terminal. At that time, the terminals may search for the communication counterpart sequentially from the entry at a higher position in the pairing information. In this case, for example, peripheral terminal 200 including pairing information 218 (the state at the lower side in FIG. 6) shown in FIG. 6 first attempts to establish the wireless connection with second wireless communication controller 104 of central terminal 100 having the address "AA:AA:AA:AA:AA:01". Consequently, peripheral terminal 200 preferentially selects second wireless communication controller 104 of central terminal 100.

When peripheral terminal 200 establishes a wireless connection to central terminal 100, it thus determines the wireless communication controller to be the connection destination among the plurality of wireless communication controllers included in central terminal 100, in accordance with the information on the plurality of wireless communication controllers provided with the priority.

Central terminal 100 can adjust the wireless communication controller to which peripheral terminal 200 is to preferentially be connected, by adjusting the order of the addresses of the wireless communication controllers included in the pairing request.

In unicast or multicast transmission of an advertising packet or a packet similar to the advertising packet as well, peripheral terminal 200 may determine the address of a transmission destination sequentially from the entry at the higher position registered in the pairing information.

In a modification, the entry may be added to the pairing information in the reverse order of transmission of the addresses in the pairing request or the pairing response.

In a modification, the pairing request or the pairing response may include information indicating the priority of the addresses. In an example where the pairing request or the pairing response includes the information indicating the priority, the order of entries added to the pairing information may be determined in accordance with the priority, rather than the order of transmission of the addresses. Alternatively, in an example where information indicating the priority is stored together with the address, any order of entries may be applicable.

In a modification, the shared key may be generated for each of wireless communication controllers of central terminal 100. Peripheral terminal 200 may associate a different shared key with each of the plurality of wireless communication controllers included in central terminal 100. In this case, processing in sequences SQ10 and SQ12 may be repeated in accordance with the number of wireless communication controllers of central terminal 100. In other words, peripheral terminal 200 may generate a plurality of shared keys.

Sequences SQ2 to SQ16 correspond to the pairing processing according to the present embodiment.

When central terminal 100 thereafter transmits an encryption start request to peripheral terminal 200 (sequence SQ18) and peripheral terminal 200 transmits response to the encryption start request to central terminal 100 (sequence SQ20), encrypted communication is started between central terminal 100 and peripheral terminal 200 (sequence SQ22).

Though exemplary processing in which central terminal 100 includes the plurality of wireless communication controllers is described for the sake of convenience of description, peripheral terminal 200 may include a plurality of wireless communication controllers. In this case, an entry for each wireless communication controller of peripheral terminal 200 is registered in pairing information 118 of central terminal 100.

In a modification, even when the shared keys held by central terminal 100 and peripheral terminal 200 match with each other in sequence SQ6, the shared key may newly be generated without suspension of the pairing processing. In another modification, processing in sequences SQ6 and SQ8 may be omitted. Central terminal 100 and peripheral terminal 200 may generate the shared key without determining whether or not the shared keys held thereby match with each other.

Central terminal 100 or peripheral terminal 200 does not have to support the first pairing processing, although it supports the second pairing processing.

Central terminal 100 including a plurality of wireless communication controllers, in establishing a wireless connection, requests peripheral terminal 200 to establish the wireless connection based on the advertising packet from peripheral terminal 200. The request for the wireless connection from central terminal 100 to peripheral terminal 200 may include information indicating to which wireless communication controller of central terminal 100 a connection should be established. For example, the request from central terminal 100 may include the address of the wireless communication controller to which peripheral terminal 200 is to establish a wireless connection. In this case, peripheral terminal 200 may establish the wireless connection not to the wireless communication controller which is a source of transmission of the request from central terminal 100 but to the wireless communication controller designated in the request.

### C. Modification

Processing necessary in a communication apparatus above may be performed by execution of a program by the processor, or a part or the entirety of the processing may be performed by hardwired circuitry such as an application specific integrated circuit (ASIC) or a field programmable gate array (FPGA). For example, the wireless communication controller may be responsible for at least a part of processing necessary in the communication apparatus above.

The term "processor" herein encompasses hardwired circuitry such as an ASIC or an FPGA in addition to the CPU or the GPU. The hardwired circuitry may be an integrated circuit (IC) small in circuit scale.

The configuration of central terminal 100 or peripheral terminal 200 is by way of example, and does not have to include at least one of features or may include another feature. For example, central terminal 100 does not have to include display 120.

Though the wireless communication controller and the wired communication controller are described in the description above as features independent of the control unit for the sake of convenience of description, the control unit may include at least a part of the wireless communication controller or the wired communication controller. The plurality of wireless communication controllers may be implemented on a single substrate. Hardware of central terminal 100 and peripheral terminal 200 may be implemented in any manner.

### D. Exemplary Effects

For example, in an example where at least one of the central terminal or the peripheral terminal includes a plurality of wireless communication controllers, the communication counterpart terminal is assumed to perform pairing processing with each of the plurality of wireless communication controllers. In this case, the first pairing processing should repeatedly be performed as many times as the number of wireless communication controllers, and it may take time for advance preparation for wireless communication.

In contrast, by adopting the second pairing processing, even when at least one of the central terminal or the peripheral terminal includes a plurality of wireless communication controllers, necessary pairing information is obtained by performing the pairing processing once. Therefore, a time period required for the pairing processing can be shorter.

Though Bluetooth® is exemplified as the wireless communication standard in the disclosure above, another standard may be applicable.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. A communication system comprising:
a first communication terminal comprising a plurality of wireless communication controllers; and
a second communication terminal comprising one or more wireless communication controllers, wherein
the first communication terminal is configured to transmit data comprising information on the plurality of wireless communication controllers in the first communication terminal to the second communication terminal,
the second communication terminal is configured to transmit data comprising information on the one or more wireless communication controllers in the second communication terminal to the first communication terminal,
the first communication terminal and the second communication terminal are each configured to generate a shared key,
the second communication terminal is configured to associate each of the plurality of wireless communication controllers in the first communication terminal with the shared key generated at the second communication terminal, and
the first communication terminal is configured to associate each of the one or more wireless communication controllers in the second communication terminal with the shared key generated at the first communication terminal.

2. The communication system according to claim 1, wherein
the data to be transmitted by the first communication terminal comprises priority information, and
the second communication terminal is configured to determine, in accordance with the priority information, a wireless communication controller to be a connection destination among the plurality of wireless communication controllers in the first communication terminal when the second communication terminal establishes a wireless connection to the first communication terminal.

3. The communication system according to claim 2, wherein
the priority information is based on an order, in the data, of information on the plurality of wireless communication controllers.

4. The communication system according to claim 1, wherein
the second communication terminal is configured to associate a single shared key with each of the plurality of wireless communication controllers in the first communication terminal.

5. The communication system according to claim 1, wherein
the second communication terminal is configured to associate a different shared key with each of the plurality of wireless communication controllers in the first communication terminal.

6. The communication system according to claim 1, wherein
the first communication terminal further comprises a wired communication controller,
the second communication terminal further comprises a wired communication controller, and
the first communication terminal is configured to transmit the data comprising the information on the plurality of wireless communication controllers in the first communication terminal to the second communication terminal when the first communication terminal is connected via a wireless connection to the second communication terminal and when the first communication terminal is connected via a wired connection to the second communication terminal.

7. The communication system according to claim 1, wherein
the first communication terminal is configured to transmit the data comprising the information on the plurality of wireless communication controllers in the first communication terminal to the second communication terminal when the first communication terminal receives predetermined information from the second communication terminal.

8. The communication system according to claim 7, wherein
the predetermined information is included in an advertising packet transmitted by the second communication terminal.

9. The communication system according to claim 7, wherein
the first communication terminal is configured to transmit the data comprising information on one wireless communication controller among the plurality of wireless communication controllers in the first communication terminal to the second communication terminal when the first communication terminal does not receive the predetermined information from the second communication terminal.

10. The communication system according to claim 1, wherein
the second communication terminal is configured to transmit information indicating a key generation scheme supported by the second communication terminal to the first communication terminal, and
the first communication terminal is configured to select at least one of the key generation scheme indicated by the information received from the second communication terminal or a predetermined key generation scheme.

11. The communication system according to claim 1, wherein
the first communication terminal and the second communication terminal are configured to determine whether shared keys that they hold match with each other, and
the first communication terminal and the second communication terminal are configured to generate the shared key when the shared keys that they hold do not match with each other.

12. A method of communication between a first communication terminal and a second communication terminal, the method comprising:
transmitting, at the first communication terminal that comprises a plurality of wireless communication controllers, data comprising information on the plurality of wireless communication controllers in the first communication terminal to the second communication terminal;
transmitting, at the second communication terminal that comprises one or more wireless communication controllers, data comprising information on the one or more wireless communication controllers in the second communication terminal to the first communication terminal;
generating, at each of the first communication terminal and the second communication terminal, a shared key;
associating, at the second communication terminal, each of the plurality of wireless communication controllers in the first communication terminal with the shared key generated at the second communication terminal; and
associating, at the first communication terminal, each of the one or more wireless communication controllers in the second communication terminal with the shared key generated at the first communication terminal.

13. A communication terminal comprising:
one or more wireless communication controllers;
one or more processors; and
one or more memories having stored therein instructions that, when executed, cause the one or more processors to perform operations comprising
transmitting data comprising information on the one or more wireless communication controllers in the communication terminal to a second communication terminal, to which the communication terminal is wirelessly connected, comprising a plurality of wireless communication controllers when the communication terminal receives data comprising information on the plurality of wireless communication controllers in the second communication terminal from the second communication terminal,
generating a shared key between the communication terminal and the second communication terminal, and
associating each of the plurality of wireless communication controllers in the second communication terminal with the generated shared key.

14. A communication method to be performed by a communication terminal comprising:
transmitting data comprising information on one or more wireless communication controllers in the communication terminal to a second communication terminal, to which the communication terminal is wirelessly connected, comprising a plurality of wireless communication controllers when the communication terminal receives data comprising information on the plurality of wireless communication controllers in the second communication terminal from the second communication terminal;
generating a shared key between the communication terminal and the second communication terminal; and
associating each of the plurality of wireless communication controllers in the second communication terminal with the generated shared key.

15. A communication terminal comprising:
a plurality of wireless communication controllers;
one or more processors; and
one or more memories having stored therein instructions that, when executed, cause the one or more processors to perform operations comprising
transmitting data comprising information on the plurality of wireless communication controllers in the communication terminal to a second communication terminal, to which the communication terminal is wirelessly connected, comprising one or more wireless communication controllers,
receiving data comprising information on the one or more wireless communication controllers in the second communication terminal from the second communication terminal,
generating a shared key between the communication terminal and the second communication terminal, and
associating each of the one or more wireless communication controllers in the second communication terminal with the generated shared key.

16. A communication method to be performed by a communication terminal comprising:
transmitting data comprising information on the plurality of wireless communication controllers in the communication terminal to a second communication terminal, to which the communication terminal is wirelessly connected, comprising one or more wireless communication controllers;
receiving data comprising information on the one or more wireless communication controllers in the second communication terminal from the second communication terminal;
generating a shared key between the communication terminal and the second communication terminal; and
associating each of the one or more wireless communication controllers in the second communication terminal with the generated shared key.
